(19) United States
(12) Patent Application Publication
(10) Pub. No.: US 2010/0215943 A1
(43) Pub. Date: Aug. 26, 2010

(54) ANTIREFLECTION FILM

(75) Inventors: Seiji SHINOHARA, Tokyo-to (JP); Hiroaki OMORI, Tokyo-to (JP)

Correspondence Address: LADAS & PARRY LLP, 224 SOUTH MICHIGAN AVENUE, SUITE 1600, CHICAGO, IL, 60604, US

(73) Assignee: DAI NIPPON PRINTING CO., LTD., Tokyo-to (JP)

(21) Appl. No.: 12/774,948

(22) Filed: May 6, 2010

Related U.S. Application Data
(62) Division of application No. 12/064,356, filed on Jun. 11, 2008.

(30) Foreign Application Priority Data
Sep. 29, 2005 (JP) 2005-284972

(51) Int. Cl. G02B 1/11; B32B 5/02

(52) U.S. Cl. 428/313.5; 428/313.3; 428/313.9

(57) ABSTRACT

An antireflection film including a low-refractive-index layer and having low reflectivity and high water resistance. The antireflection film has a low-refractive-index layer composed of two layers. The two layers include a first layer with void-containing inorganic fine particles and a second layer that is formed on the first layer and has a fluorine atom-containing cured film or a gas barrier inorganic thin film.

### TECHNICAL FIELD

The invention relates to an antireflection film and more specifically to an antireflection film that includes a low-refractive-index layer containing void-containing inorganic fine particles and has low reflectivity and high water resistance.

### BACKGROUND ART

The screen of an image display such as a liquid crystal display (LCD), a cathode ray tube (CRT) display, and a plasma display panel (PDP) is required to reduce reflecting light from external light sources such as fluorescent lamps and to have high visibility. Based on the phenomenon that the reflectance of a transparent matter is reduced when its surface is covered with a low-refractive-index transparent film, therefore, such visibility has been improved by placing an antireflection film on the screen of an image display such that the reflectivity of the screen can be reduced.

There are various methods for a reduction in refractive index. A method includes placing air (1 in refractive index) in the interior of a film to reduce the refractive index of the whole of the film.

Concerning such a low-refractive-index layer containing air in the interior of a film, for example, Patent Document 1 discloses that in order to have low refractive index and high mechanical strength, an antireflection film should have a low-refractive-index layer that includes an ionizing radiation-curable resin composition, silica fine particles each comprising an outer shell layer and a porous or hollow interior, and a silane coupling agent having an ionizing radiation-curable group with which the surface of the silica fine particles is at least partially treated.

### Patent Document 1: Japanese Patent Application Laid-Open (JP-A) No. 2005-99778

### Patent Document 2: JP-A No. 2003-202406

### DISCLOSURE OF THE INVENTION

### Problems to be Solved by the Invention

The low-refractive-index layer of the antireflection film is generally placed on the uppermost side and thus required to have water resistance, because if water is adsorbed to the antireflection film, color change can occur. However, it has been found that an antireflection film including void-containing inorganic fine particles that are used to add air to the film such that the refractive index can be reduced tends to absorb water into the voids over time and thus has low water resistance. For example, when water is absorbed into the voids, the refractive index of the void-containing inorganic fine particles is increased. Therefore, a problem arises in which reflectance degradation can occur over time, or a poor appearance such as water stain can be produced, or the scratch resistance or the like can degrade over time.

The antireflection film of Patent Document 1 has high mechanical strength but is not designed taking water resistance into account.

In order to provide an antireflection film that includes a single antireflection layer and has high antireflection performance and antifouling properties, Patent Document 2 proposes that an antifouling layer having water repellency/oil repellency is provided on the surface of a low-refractive-index layer including hollow silica fine particles. However, the antifouling layer of such an antireflection film is formed mainly for the purpose of preventing adhesion of dirt such as fingerprints and is generally a thin film that has a thickness of less than 10 nm so as not to influence the refractive index. Therefore, the antifouling layer initially has water repellency but is insufficient to provide water resistance over time for the silica fine particles present at or near the uppermost surface of the low-refractive-index layer.

The invention has been made under the circumstances described above, and an object of the invention is to provide an antireflection film having low reflectivity and high water resistance.

### Means for Solving the Problems

The invention is directed to an antireflection film comprising a low-refractive-index layer composed of two layers, the two layers comprising a first layer comprising void-containing inorganic fine particles and a second layer that is formed on the first layer and comprises a fluorine atom-containing cured film or a gas barrier inorganic thin film.

In the antireflection film of the invention, the first layer comprising the void-containing inorganic fine particles primarily provides low refractive index properties, while the second layer that is formed on the first layer and comprises a fluorine atom-containing cured film or a gas barrier inorganic thin film primarily provides waterproof properties. The thickness and refractive index of both layers are properly controlled so that both layers can work together to form the low-refractive-index layer. Because of the waterproof second layer placed on the first layer, water is less likely to be absorbed into the void of the inorganic fine particles in the first layer, so that water resistance is imparted to the low-refractive-index layer containing voids dispersed in the film. Therefore, the resulting antireflection film has low reflectivity and high water resistance at the same time. According to the invention, the second layer of the low-refractive-index layer comprises a fluorine atom-containing cured film or a gas barrier inorganic thin film. Therefore, the second layer can not only prevent degradation of appearance such as formation of water stain but also have high scratch resistance and high reflectance stability over time.

In view of water resistance, the antireflection film of the invention preferably has a water vapor permeability of 50 g/m² per day or less in a measurement under the conditions of 40° C. and 90% RH according to JIS K 7129.

In view of water resistance, the antireflection film of the invention preferably shows a minimum reflectance difference of 0.1% or less and a haze difference of 0.1% or less according to JIS K 7361, before and after a process that includes dropping 1 mL of ion exchanged water on the surface of the antireflection film, allowing the film to stand at 25° C. for 24 hours, and then wiping the water drop off the surface.

In the antireflection film of the invention, the second layer comprising the fluorine atom-containing cured film is preferably formed by a reaction of an ionizing radiation-curable functional group and/or a heat-curable functional group, so that the film can have a high level of water resistance, scratch resistance and productivity.

In the antireflection film of the invention, the void-containing inorganic fine particles preferably have a refractive index of 1.45 or less. In this case, the antireflection film is particularly effective in preventing reflection.

In the antireflection film of the invention, the second layer in the low-refractive-index layer preferably has a thickness of 5 nm to 50 nm, in view of water resistance.

### Effects of the Invention

According to the invention, a low-refractive-index layer that comprises void-containing inorganic fine particles and simultaneously achieves water resistance and low refractive index properties is provided so that there is provided an antireflection film that has low reflectivity and high water resistance and resists degradation in reflectance, appearance, scratch resistance, or the like over time.

### BRIEF DESCRIPTION OF THE DRAWINGS

FIG. 1 is a cross-sectional view schematically showing an example of the antireflection film of the invention.

### DESCRIPTION OF REFERENCE NUMERALS

1 antireflection film
2 optically-transparent substrate
3 low-refractive-index layer (first layer)
4 low-refractive-index layer (second layer)
5 hard coat layer

### BEST MODE FOR CARRYING OUT THE INVENTION

The antireflection film of the invention includes a low-refractive-index layer composed of two layers. The two layers includes a first layer comprising void-containing inorganic fine particles and a second layer that is formed on the first layer and comprises a fluorine atom-containing cured film or a gas barrier inorganic thin film.

In the antireflection film of the invention, the first layer comprising the void-containing inorganic fine particles primarily provides low refractive index properties, while the second layer that is formed on the first layer and comprises a fluorine atom-containing cured film or a gas barrier inorganic thin film primarily provides waterproof properties. The thickness and refractive index of both layers are properly controlled so that both layers can work together to form the low-refractive-index layer. Because of the waterproof second layer placed on the first layer, water is less likely to be absorbed into the void of the inorganic fine particles in the first layer, so that water resistance is imparted to the low-refractive-index layer containing voids dispersed in the film. Therefore, the resulting antireflection film has low reflectivity and high water resistance at the same time. According to the invention, the second layer of the low-refractive-index layer comprises a fluorine atom-containing cured film or a gas barrier inorganic thin film. Therefore, the second layer can not only prevent degradation of appearance such as formation of water stain but also have high scratch resistance and high reflectance stability over time.

The antireflection film of the invention has the advantage that it can achieve a refractive index lower than that of a fluoropolymer low-refractive-index layer or any other layer with no problem with waterproof properties, because it includes a low-refractive-index layer comprising void-containing inorganic fine particles.

The antireflection film of the invention comprises at least the low-refractive-index layer composed of the specific two layers. The antireflection film of the invention may comprise only the low-refractive-index layer. Alternatively, the antireflection film of the invention may include the low-refractive-index layer and one or more functional layers and/or an optically-transparent substrate, wherein the low-refractive-index layer may be placed on the one or more functional layers and/or the optically-transparent substrate so as to form an uppermost surface.

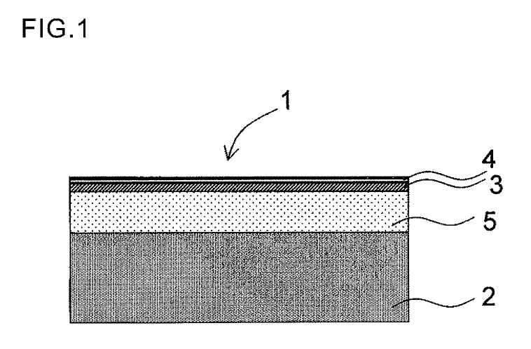

FIG. 1 is a cross-sectional view schematically showing an example of the antireflection film of the invention. An antireflection film 1 includes an optically-transparent substrate 2 and a low-refractive-index layer 3 (a first layer) and another low-refractive-index layer 4 (a second layer) that are formed on one side of the substrate 2 in this order. The antireflection film 1 further includes a hard coat layer 5 placed between the optically-transparent substrate 2 and the low-refractive-index layer 3 (the first layer). In this embodiment, there is provided an optically-transparent layer comprising only the low-refractive-index layer composed of the two layers. However, the optically-transparent layer may also further comprise any other optically-transparent layer with a different refractive index.

Examples of the layered structure of the antireflection film of the invention include, but are not limited to, stand-alone low-refractive-index layer, substrate/low-refractive-index layer, substrate/hard coat layer/low-refractive-index layer, substrate/antistatic layer/hard coat layer/low-refractive-index layer, substrate/antistatic layer/hard coat layer/high-refractive-index layer/low-refractive-index layer, substrate/antistatic layer/hard coat layer/medium-refractive-index layer/high-refractive-index layer/low-refractive-index layer, and substrate/hard coat layer/antistatic layer/low-refractive-index layer. In these structures, “low-refractive-index layer” corresponds to the low-refractive-index layer composed of the two specific layers according to the invention.

Elements according to the invention are described below in order from the low-refractive-index layer, the essential layer, to other elements.

<Low-Refractive-Index Layer>

The low-refractive-index layer according to the invention comprises the first layer comprising void-containing inorganic fine particles and the second layer that is formed on the first layer and comprises a fluorine atom-containing cured film or a gas barrier inorganic thin film. It may have a thickness of about 100 nm, in view of low-refractive-index properties and transparency.

In the low-refractive-index layer according to the invention, the second layer primarily providing waterproof properties (hereinafter, also simply referred to as “waterproof layer”) is formed on the first layer primarily providing low-refractive-index properties, and the thickness and refractive index of both layers are properly controlled so that both layers can work together to form the low-refractive-index layer.

In an embodiment of the invention, the refractive index of the low-refractive-index layer may be controlled by controlling the thickness and refractive index of the first and second layers. In an embodiment of the invention, a process for controlling the refractive index of the low-refractive-index layer to the desired value includes first taking into account the refractive index and thickness dependent on the material for the second waterproof layer and controlling the amount of the addition of the void-containing inorganic fine particles to the first layer and controlling the thickness of the first layer, which is primarily responsible for the control of the low-refractive-index properties, based on the information taken into account. The void-containing inorganic fine particles used for the first layer have relatively high hardness. Therefore, the low-refractive-index layer formed with a mixture of the void-containing inorganic fine particles and a binder can have an improved strength and a controlled refractive index in the range of about 1.2 and about 1.45. In an embodiment of the invention, therefore, the refractive index of the low-refractive-index layer is preferably 1.40 or less, more preferably 1.35 or less.

In order to provide a low degree of reflection, the first and second layers of the low-refractive-index layer preferably work together to satisfy the mathematical formula (I): (m/4)λ×0.7<n₁d₁<(m/4)λ×1.3, wherein m is a positive odd number, n₁ is the refractive index of the low-refractive-index layer, d₁ is the thickness (nm) of the low-refractive-index layer, and λ is a wavelength in the range of 380 to 780 nm.

Satisfying the mathematical formula (I) means the existence of m (a positive odd number, generally 1) satisfying the expression (I) in the wavelength range.

[First Layer]

In an embodiment of the invention, the first layer of the low-refractive-index layer includes void-containing inorganic fine particles as an essential component and may generally further include a binder component for imparting film formability and optionally any appropriate additive.

(Void-Containing Inorganic Fine Particles)

As used herein, the term “void-containing inorganic fine particles” is intended to include fine particles having a gas-filled internal structure and/or a gas-containing porous structure and having a refractive index decreased inversely proportional to the population of the gas in the fine particles as compared with the refractive index of the void-free inorganic fine particles. In an embodiment of the invention, void-containing inorganic fine particles also include fine particles capable of forming a nanoporous structure in at least part of the interior and/or the surface depending on the shape, structure or aggregation state of the fine particles or depending on the state of dispersion of the fine particles in the film. The void-containing inorganic fine particles contribute to the reduced refractive index of the low-refractive-index layer, while keeping the strength of the low-refractive-index layer.

For example, the void-containing inorganic fine particles for use in the antireflection film of the invention may be made of metal or metal oxide. Examples of such particles include composite oxide sol and hollow silica fine particles as disclosed in JP-A Nos. 07-133105 and 2001-233611. In particular, hollow silica fine particles prepared by the technique disclosed in JP-A No. 2001-233611 is preferred.

Specifically, hollow silica fine particles or other void-containing inorganic fine particles may be produced by a process including the first, second and third steps described below.

The first step includes previously preparing an alkaline aqueous solution of a silica material and an alkaline aqueous solution of an inorganic oxide material other than the silica independently or previously preparing an aqueous solution of a mixture of both materials, and then gradually adding the resulting aqueous solution or solutions to an alkaline aqueous solution with a pH of 10 or more under stirring, depending on the composition of the desired composite oxide. Alternatively, the first step may include providing a seed particles-containing dispersion liquid as a starting material in advance.

The second step includes selectively removing at least part of elements other than silicon and oxygen from the colloidal particles of the composite oxide obtained in the first step. Specifically, such elements may be removed from the composite oxide by solubilization with a mineral acid or an organic acid or by ion exchange with a cation-exchange resin brought into contact therewith.

The third step includes adding a hydrolyzable organo-silicon compound, silicate solution or the like to the colloidal particles of the composite oxide with some elements at least partially removed therefrom so that the surface of the colloidal particles is coated with a polymer of the organo-silicon compound, the silicate or the like. As a result, the composite oxide sol disclosed in the publication is produced.

Examples of the fine particles that may be used include not only the silica fine particles capable of forming a nanoporous structure in at least part of the interior and/or the surface of the film but also sustained-release materials that are produced to have a large specific surface area and to allow various chemical substances to adsorb onto a packed column and a surface porous part; porous fine particles used for fixing catalysts; and a dispersion or aggregate of hollow fine particles to be incorporated into heat insulating materials or low-permittivity materials. Specific examples of such particles include commercially available products, and an aggregate of porous silica fine particles may be selected and used from Nipsil (trade name) and Nipgel (trade name) series manufactured by Nippon Silica Industries Co., Ltd., and fine particles that fall within a preferred particle size range according to the invention may be selected and used from Colloidal Silica UP series (trade name) having a chain structure of silica fine particles manufactured by Nissan Chemical Industries Ltd.

In a preferred mode, the void-containing inorganic fine particles are further surface-treated with a silane coupling agent having an acryloyl group and/or a methacryloyl group. The surface treatment of the inorganic fine particles allows an increase in the affinity of the inorganic fine particles for a binder mainly composed of an ionizing radiation-curable resin composition and allows uniform dispersion of the inorganic fine particles in a coating liquid or a coating film so that a reduction in transparency or coating film strength due to aggregation or agglomeration of the inorganic fine particles can be prevented. The acryloyl group and/or the methacryloyl group facilitates the reaction with the ionizing radiation-curable group of the binder so that advantageously the inorganic fine particles in the coating film can be fixed to the binder component and the silica fine particles can act as a crosslinking agent in the binder. This produces the effect of tightening the whole of the film to increase the hardness of the coating film and provides hardness while maintaining the original flexibility of the binder component.

In an embodiment of the invention, the void-containing inorganic fine particles may be spherical, needle-like or the like. The average particle size of the void-containing spherical inorganic fine particles is preferably from 1 nm to 100 nm and more preferably has a lower limit of 10 nm or more and an upper limit of 50 nm or less. If the average particle size of the fine particles is more than 100 nm, the transparence can be reduced. If the average particle size of the fine particles is less than 1 nm, it could be difficult to disperse the fine particles. The fine particles with an average particle size in this range allow the low-refractive-index layer to have a high level of transparency.

The refractive index of the void-containing inorganic fine particles is preferably 1.45 or less, more preferably 1.30 or less, in order that the low-refractive-index layer may have a sufficiently low refractive index and that the strength of the fine particles themselves may be maintained.

In an embodiment of the invention, the first layer of the low-refractive-index layer preferably contains 10% by mass or more of the void-containing inorganic fine particles, based on the total mass of the first layer, in terms of providing the desired refractive index. In view of film strength, water resistance and so on, the content of the void-containing inorganic fine particles is more preferably from 15 to 95% by mass, still more preferably from 20 to 70% by mass, based on the total mass of the first layer.

In an embodiment of the invention, the first layer of the low-refractive-index layer may further comprise any of the materials described below, in addition to the void-containing inorganic fine particles.

(Binder Component)

In an embodiment of the invention, a binder component may be added to the first layer of the low-refractive-index layer in order to impart film formability or adhesion to the substrate or the adjacent layer.

Examples of such a useful binder component include (i) reactive binder components capable of being activated and cured by light, heat or the like, such as binder components capable of being activated and cured by electromagnetic waves or energy particle beams, such as visible light, ultraviolet rays, and electron beams (hereinafter referred to as “photo-curable binder component”) and binder components capable of being activated and cured by heat (hereinafter referred to as “thermosetting binder component”); and (ii) non-reactive binder components not capable of being activated by light, heat or the like but capable of being solidified by drying or cooling, such as thermoplastic resins or the like that can form an optically-transparent coating film when solidified or hardened.

Among these binder components, photo-curable binder components, particularly ionizing radiation-curable binder components can form a coating composition of high coatability and can form a uniform, large-area, coating film. If the binder component in the coating film is cured by photopolymerization after the coating process, a coating film of relatively high strength can be obtained.

A monomer, an oligomer and a polymer each having a polymerizable functional group that can promote a large molecule-forming reaction such as dimerization and polymerization directly upon ionizing irradiation or indirectly under the action of an initiator may be used as the ionizing radiation-curable binder component. In an embodiment of the invention, a radical-polymerizable monomer or oligomer having an ethylenically unsaturated bond group such as an acrylic, vinyl or allyl group may be used, optionally in combination with a photopolymerization initiator. However, any other ionizing radiation-curable binder component may also be used such as a photocationically polymerizable monomer or oligomer including an epoxy group-containing compound. If necessary, the photocationically-polymerizable binder component may be used in combination with a photo-cation initiator. The binder component is preferably a polyfunctional binder component having two or more polymerizable functional groups in a single molecule such that crosslink can be formed between the binder component molecules.

Preferred examples of useful ethylenically unsaturated bond-containing monomers and oligomers include di(meth)acrylates such as ethylene glycol di(meth)acrylate and pentaerythritol di(meth)acrylate monostearate; tri(meth)acrylates such as methylolpropane tri(meth)acrylate and pentaerythritol tri(meth)acrylate; polyfunctional (meth)acrylates such as pentaerythritol tetra(meth)acrylate and dipentaerythritol penta(meth)acrylate; derivatives thereof such as EO-modified products thereof; and oligomers of any of the above radical-polymerizable monomers.

Also preferably used are oligomers with a number average molecular weight (a polystyrene-equivalent number average molecular weight determined by GPC method) of 20,000 or less, such as epoxy acrylate resins (such as Epoxy Ester series manufactured by Kyoeisha Chemical Co., Ltd. and Epoxy series manufactured by Showa Highpolymer Co., Ltd.) and urethane acrylate resins produced by polyaddition of various isocyanates with hydroxyl group-containing monomers through a urethane bond (such as Shiko series manufactured by The Nippon Synthetic Chemical Industry Co., Ltd. and Urethane Acrylate series manufactured by Kyoeisha Chemical Co., Ltd.). These monomers and oligomers are highly effective in increasing the crosslink density of the coating film. Because of their molecular weight of at most 20,000, these monomers and oligomers are fluid components and thus can also be effective in improving the coatability of the coating composition.

If necessary, a reactive polymer of a number average molecular weight of 20,000 or more having a (meth)acrylate group in the main or side chain may also preferably be used. These reactive polymers are commercially available, for example, as Macromonomer manufactured by Toagosei Co., Ltd. or may be obtained as acrylate group-containing reactive polymers by a process including the steps of previously forming a copolymer of methyl (meth)acrylate and glycidyl methacrylate and then condensing the glycidyl group of the copolymer with the carboxyl group of (meth)acrylic acid. The addition of such a component of a high molecular weight allows an improvement in the film formability for complicated geometry and a reduction in curing or warping of the antireflection film due to volume reduction during curing.

The ionizing radiation-curable binder component may also be used in combination with a non-reactive polymer or a different-reaction-type polymerizable monomer, oligomer or polymer such as a thermosetting binder component typified by epoxy resins. Examples of the binder component that is non-reactive by itself include non-polymerizable transparent resins conventionally used for forming optical thin films, such as polyacrylic acid, polymethacrylic acid, polyacrylate, polymethacrylate, polyolefin, polystyrol, polyamide, polyimide, polyvinyl chloride, polyvinyl alcohol, polyvinyl butyral, and polycarbonate. Examples of the thermosetting binder component that may be used include monomers, oligomers and polymers each having a curable functional group such that a large molecule-forming reaction such as polymerization and crosslinking can be promoted for curing between the same or different functional groups. Such thermosetting resins may be monomers or oligomers having an alkoxy group, a hydroxyl group, a carboxyl group, an amino group, an epoxy group, or a hydrogen bond-forming group. Examples of thermosetting resins that may be used include phenol reins, urea resins, diallyl phthalate resins, melamine resins, guanamine resins, unsaturated polyester resins, polyurethane resins, epoxy resins, aminoalkyd resins, melamine-urea cocondensated resins, silicon resins, and polysiloxane resins. If necessary, these thermosetting resins may be mixed with a curing agent such as a crosslinking agent and a polymerization initiator, a polymerization promoter, a solvent, a viscosity modifier, or the like, before use.

In an embodiment of the invention, the first layer of the low-refractive-index layer preferably contains 5 to 85% by mass of, more preferably 30 to 50% by mass of the binder component, based on the total mass of the first layer, in view of film formability, film strength or the like.

(Photopolymerization Initiator)

When the binder component for use in the invention is ionizing radiation-curable, a photopolymerization initiator is preferably used to initiate photopolymerization. The photopolymerization initiator may be appropriately selected from photo-radical initiators, photo-cation initiators and so on depending on the ionizing radiation-curing reaction type of the binder component. Examples of the photopolymerization initiator include, but are not limited to, acetophenones, benzophenones, ketals, anthraquinones, disulfide compounds, thiuram compounds, and fluoroamine compounds. More specifically, examples thereof include 1-hydroxy-cyclohexyl-phenyl-ketone, 2-methyl-1[4-(methylthio)phenyl]-2-morpholinopropane-1-one, benzyl dimethyl ketone, 1-(4-dodecylphenyl)-2-hydroxy-2-methylpropane-1-one, 2-hydoxy-2-methyl-1-phenylpropane-1-one, 1-(4-isopropylphenyl)-2-hydroxy-2-methylpropane-1-one, and benzophenone. In particular, 1-hydroxy-cyclohexyl-phenyl-ketone and 2-methyl-1[4-(methylthio)phenyl]-2-morpholinopropane-1-one are preferably used in an embodiment of the invention, because even in a small amount, they can initiate and promote the ionizing irradiation-induced polymerization reaction. One or both of them may be used alone or in combination. They are commercially available, and for example, 1-hydroxy-cyclohexyl-phenyl-ketone is available under the trade name Irgacure 184 from Ciba Specialty Chemicals Inc.

When the photopolymerization initiator is used, 3 to 8 parts by mass of the photopolymerization initiator is preferably added to 100 parts by mass of the ionizing radiation-curable binder component.

In an embodiment, the first layer of the low-refractive-index layer may also contain any other component such as an ultraviolet blocking agent, an ultraviolet absorbing agent, and a surface control agent (a leveling agent). Even the first layer may also contain internal void-free fine particles, in addition to the void-containing inorganic fine particles.

In an embodiment of the invention, the thickness of the first layer of the low-refractive-index layer is preferably from 40 to 100 nm, more preferably from 60 to 80 nm, while it may be appropriately adjusted depending on the refractive index and thickness of the second layer.

[Second Layer]

In an embodiment of the invention, the second layer of the low-refractive-index layer primarily functions as a waterproof layer for the first layer, while it works together with the first layer to form the low-refractive-index layer. The second layer comprises a fluorine atom-containing cured film or a gas barrier inorganic thin film. The second layer comprising the fluorine atom-containing cured film and the second layer comprising the gas barrier inorganic thin film are described below in this order.

(1) The Second Layer Comprising Fluorine Atom-Containing Cured Film

The fluorine atom-containing cured film forming the second layer can contribute to a reduction in the refractive index of the coating film and provide water repellency or higher performance, namely water resistance. Examples of the fluorine atom-containing cured film include (i) a film produced by curing a fluorine-containing curable monomer, oligomer and/or polymer containing a fluorine atom and a curable functional group in the molecule; (ii) a film produced by curing a composition containing a fluorine-containing non-curable monomer, oligomer or polymer having a fluorine atom in the molecule but not having any curable functional group in the molecule and a fluorine-free curable monomer, oligomer or polymer containing a curable functional group in the molecule but not having any fluorine atom; (iii) a film produced by curing a composition containing the fluorine-containing curable monomer, oligomer and/or polymer and the fluorine-free curable monomer, oligomer and/or polymer; (iv) a film produced by curing a composition containing fluorine-containing inorganic fine particles and the fluorine-free curable monomer, oligomer and/or polymer; and (v) a film produced by curing a composition containing fluorine-containing inorganic fine particles and the fluorine-containing curable monomer, oligomer and/or polymer.

In particular, the fluorine atom-containing cured film is preferably produced by curing a composition comprising a mixture of a fluorine-containing curable polymer and a fluorine-containing curable monomer or oligomer and/or a fluorine-free curable monomer or oligomer, more preferably produced by curing a composition containing a mixture of a fluorine-containing curable polymer and a fluorine-containing monomer or oligomer having two or more curable functional groups in a single molecule and/or a fluorine-free curable monomer or oligomer having two or more curable functional groups in a single molecule. In this case, the fluorine-containing curable polymer can increase the film formability of the coating composition, and the fluorine-containing curable monomer or oligomer and/or the fluorine-free curable monomer or oligomer can increase the crosslink density and the coatability, so that a high level of hardness and strength can be imparted to the coating film when both components are balanced. In this case, a fluorine-containing curable polymer with a number average molecular weight (a polystyrene-equivalent number average molecular weight determined by GPC method) of 20,000 to 500,000 is preferably used in combination with a fluorine-containing curable monomer or oligomer with a number average molecular weight of 20,000 or less and/or a fluorine-free curable monomer or oligomer with a number average molecular weight of 20,000 or less so that physical properties such as coatability, film formability, film hardness, and film strength can be easily controlled.

Examples of the curable functional group include ionizing radiation-curable functional groups including ethylenically unsaturated bond-containing, radical-polymerizable groups such as acrylic, vinyl and allyl groups as described for the binder of the first layer; photo-cation polymerizable groups such as an epoxy group; and heat-curable functional groups including any appropriate combination of an alkoxy group, a hydroxyl group, a carboxyl group, an amino group, an epoxy group, a hydrogen bond-forming group, and so on. The fluorine-free curable monomer, oligomer or polymer may be one or more selected from the ionizing radiation-curable resins and the thermosetting resins as described for the binder component of the first layer. When curable functional groups capable of reacting with each other are used in combination for the first and second layers, respectively, the first and second layers can have a good affinity for each other and react with each other. Therefore, the first layer may be half cured, and then the second layer may be applied and cured, so that the adhesion between the first and second layers can be further improved.

Specifically, a fluorine-containing curable monomer having a hydrocarbon skeleton is preferably used. Examples of such a fluorine-containing curable monomer include fluoroolefins (such as fluoroethylene, vinylidene fluoride, tetrafluoroethylene, hexafluoropropylene, perfluorobutadiene, perfluoro-2,2-dimethyl-1,3-dioxole), partially or fully fluorinated alkyl, alkenyl or aryl acrylate or methacrylate esters (such as compounds represented by Formula (1) or Formula (2) below), partially or fully fluorinated vinyl ethers, partially or fully fluorinated vinyl esters, and partially or fully fluorinated vinyl ketones.

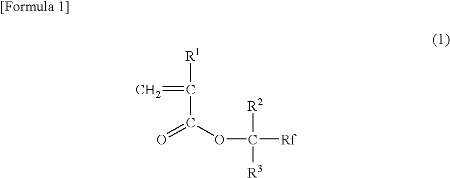

In the formula, R¹ represents a hydrogen atom, an alkyl group of 1 to 3 carbon atoms or a halogen atom, R² and R³ each independently represent a hydrogen atom, an alkyl group, an alkenyl group, a heterocyclic group, an aryl group, or a group defined as Rf, wherein Rf represents an fully or partially fluorinated alkyl, alkenyl, heterocyclic, or aryl group, R¹, R², R³, and Rf may each have a substituent other than a fluorine atom, and two or more of R², R³ and Rf may be linked to one another to form a cyclic structure.

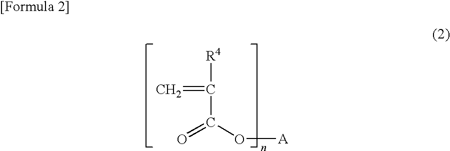

In the formula, A represents a fully or partially fluorinated organic group with a valence of n, R⁴ represents a hydrogen atom, an alkyl group of 1 to 3 carbon atoms or a halogen atom, and R⁴ may have a substituent other than a fluorine atom, and q is an integer of 2 to 8.

Examples of the compounds represented by Formula (2) above include fully or partially fluorinated diacrylates such as fully or partially fluorinated pentaerythritol diacrylate, ethylene glycol diacrylate and pentaerythritol diacrylate monostearate; fully or partially fluorinated tri(meth)acrylates such as fully or partially fluorinated trimethylolpropane triacrylate and pentaerythritol triacrylate; fully or partially fluorinated polyfunctional (meth)acrylates such as fully or partially fluorinated pentaerythritol tetraacrylate derivatives and dipentaerythritol pentaacrylate; and oligomers of any of the above radical-polymerizable monomers.

The fluorine-containing polymer having fluorine in the molecule is preferably, but not limited to, a hydrocarbon skeleton-containing fluoropolymer. Examples of the fluorine-containing polymer that may be used include homopolymers or copolymers of one or more fluorine-containing curable monomers appropriately selected from the fluorine-containing monomers described above; and copolymers of one or more fluorine-containing curable monomers and one or more fluorine-free curable monomers. Examples of such polymers include polytetrafluoroethylene, b 4-fluoroethylene-6-fluoropropylene copolymers, 4-fluoroethylene-perfluoro(alkyl vinyl ether) copolymers, 4-fluoroethylene-ethylene copolymers, polyvinyl fluoride, polyvinylidene fluoride, (co)polymers of partially or fully fluorinated alkyl, alkenyl or aryl acrylate or methacrylate esters (such as the compounds represented by Formula (1) or (2) above), fluoroethylene-hydrocarbon vinyl ether copolymers, and fluorine-modified products of various resins such as epoxy, polyurethane, cellulose, phenol, polyimide, and silicone resins. A commercially available product such as Cytop (trade name) manufactured by Asahi Glass Co., Ltd. may also be used.

In an embodiment of the invention, a polyvinylidene fluoride derivative represented by Formula (3) below is particularly preferred, because it has a low refractive index and high compatibility with other binders and allows the introduction of a curable functional group.

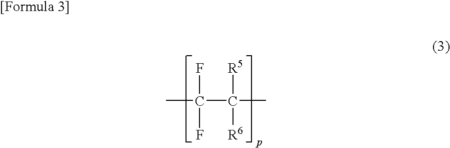

In the formula, R⁵ represents a hydrogen atom, an alkyl group of 1 to 3 carbon atoms or a halogen atom, R⁶ represents a fully or partially fluorinated vinyl, (meth)acrylate, epoxy, oxetane, aryl, maleimide, hydroxyl, carboxyl, amino, amide, or alkoxy group bonded directly or through a fully or partially fluorinated alkyl, alkenyl, ester, or ether chain, and p is from 100 to 100,000.

In the polyvinylidene fluoride derivative represented by Formula (3), examples of R⁶ include a fully or partially fluorinated di(meth)acrylate such as fully or partially fluorinated pentaerythritol diacrylate, ethylene glycol di(meth)acrylate or pentaerythritol di(meth)acrylate monostearate; a fully or partially fluorinated tri(meth)acrylate such as fully or partially fluorinated trimethylolpropane tri(meth)acrylate or pentaerythritol tri(meth)acrylate; a fully or partially fluorinated polyfunctional (meth)acrylate such as a full or partially fluorinated pentaerythritol tetra(meth)acrylate derivative or dipentaerythritol pentaacrylate, or an oligomer of any of the above radical-polymerizable monomers, wherein they are bonded directly or through a fully or partially fluorinated alkyl, alkenyl, ester, or ether chain.

In an embodiment of the invention, the fluorine atom-containing cured film is particularly preferably a cured film produced by curing a composition comprising a mixture of a fluorine-containing curable polymer of the polyvinylidene fluoride derivative represented by Formula (3) in which R⁶ has a (meth)acrylate group and the fluorine-containing curable monomer represented by Formula (1) or (2) and/or the fluorine atom-free ionizing radiation-curable monomer or oligomer as described for the binder component of the first layer. One or more fluorine-containing curable polymers, one or more fluorine-containing curable monomers, or one or more fluorine atom-free ionizing radiation-curable monomers may be used alone or in combination.

The monomer or oligomer can improve the crosslink density and workability, and the polymer can improve the film formability of the composition. Therefore, various properties such as the film formability, the coatability, the crosslink density of ionizing radiation curing, the fluorine atom content, and the content of the heat-curable polar group may be controlled by properly controlling the content of each component.

In another embodiment, the fluorine atom-containing cured film may be (ii) a film produced by curing a composition containing a fluorine-containing non-curable monomer, oligomer or polymer and a fluorine-free curable monomer, oligomer or polymer. In this case, the fluorine-containing non-curable monomer, oligomer or polymer may be any compound containing a fluorine atom, such as a fluoride additive having a perfluoroalkyl group represented by the formula C_{d}F_{2d+1}, wherein d is an integer of 1 to 21, a perfluoroalkylene group represented by the formula —(CF₂CF₂)_{g}—, wherein g is an integer of 1 to 50, a perfluoroalkyl ether group represented by the formula F—(—CF(CF₃)CF₂O—)ₑ—CF(CF₃), wherein e is an integer of 1 to 50, or a perfluoroalkenyl group such as CF₂═CFCF₂CF₂—, (CF₃)₂C═C(C₂F₅)— and ((CF₃)₂CF)₂C═C(CF₃)—; and a fluorosilane compound having a silicon compound moiety in the molecule.

In another embodiment, the fluorine atom-containing cured film may be (iv) a film produced by curing a composition containing fluorine-containing inorganic fine particles and the fluorine-free curable monomer, oligomer and/or polymer; or (v) a film produced by curing a composition containing fluorine-containing inorganic fine particles and the fluorine-containing curable monomer, oligomer and/or polymer. In this case, examples of the fluorine-containing inorganic fine particles include fine particles of metal fluoride such as magnesium fluoride, calcium fluoride, lithium fluoride, and aluminum fluoride.

When the fluorine atom-containing cured film is used as the second layer, the thickness of the second layer is preferably from 5 to 50 nm, more preferably from 10 to 50 nm, still more preferably from 10 to 30 nm, in view of water resistance.

When the fluorine atom-containing cured film is used as the second layer, the refractive index of the second layer is preferably from 1.40 to 1.47 in terms of providing water resistance and achieving low refractive index properties.

The second layer of the low-refractive-index layer may further contain any component other than the above components. If necessary, for example, a curing agent, a crosslinking agent, an ultraviolet blocking agent, an ultraviolet absorbing agent, a surface control agent (leveling agent), or the like may also be used. The second layer may be placed on the uppermost side of the antireflection film of the invention. Therefore, if necessary, a silicone additive or the like may be appropriately used in combination, so that various properties such as antifouling properties, water repellency, oil repellency, lubricity, scratch resistance, durability, and leveling properties can be controlled for the establishment of the desired function.

The second layer of the fluorine atom-containing cured film also preferably has gas barrier properties. When only the second layer is formed on an optically-transparent substrate (for example, an 80 (m thick triacetylcellulose (TAC) film) for use in the antireflection film, the laminate of the optically-transparent substrate and the second layer preferably has a water vapor permeability of 50 g/m2 per day or less, more preferably of 10 g/m2 per day or less, in the measurement using a water vapor-gas permeability meter (PERMATRAN-W3/31 manufactured by Modern Control Inc.) under the conditions of 40 (C and 90% RH according to JIS K 7129.

(2) The Second Layer Comprising Gas Barrier Inorganic Thin Film

The gas barrier properties of the gas barrier inorganic thin film used as the second layer of the low-refractive-index layer in an embodiment of the invention means that the film is capable of blocking oxygen and water vapor. When the inorganic thin film as the second layer is formed on an optically-transparent substrate (for example, an 80 (m thick triacetylcellulose (TAC) film) for use in the antireflection film, the gas barrier properties maybe evaluated based on whether or not a laminate of the optically-transparent substrate and the second layer has a water vapor permeability of 50 g/m2 per day or less in the measurement using a water vapor-gas permeability meter (PERMATRAN-W3/31 manufactured by Modern Control Inc.) under the conditions of 40 (C and 90% RH according to JIS K 7129.

The gas barrier inorganic thin film used for the second layer should also be transparent, because it should maintain visibility. From this point of view, the gas barrier inorganic thin film used for the second layer is preferably a thin film with a thickness of 50 nm or less produced with silicone oxide, aluminum oxide, silicon nitride, silicon oxide nitride, or the like by an electron-beam evaporation method, a sputtering method, a plasma CVD method (CVD is an abbreviation for Chemical Vapor Deposition and also referred to as chemical vapor-phase deposition or chemical deposition), or an atmospheric pressure plasma discharge method. In view of transparency, a silicon oxide film is particularly preferred. In view of barrier properties, aluminum oxide is also preferred.

The second layer of the gas barrier inorganic thin film preferably has a thickness of 5 to 50 nm, more preferably of 10 to 30 nm, in view of water resistance.

[Method for Forming the Low-Refractive-Index Layer]

The first layer and the second layer of the fluorine atom-containing cured film may be generally formed by a process that includes dissolving each component in a solvent and subjecting each component to a dispersion process according to a general preparation method to form a layer-forming coating liquid, applying the layer-forming coating liquid to an optically-transparent substrate, one or more functional layers, or the first layer, and drying and curing the coating. When the second layer of the fluorine atom-containing cured film is formed on the first layer, the first layer may be formed as a half-cured film, and then the second layer of the cured film may be formed thereon, so that good adhesion can be provided between the first and second layers. When the gas barrier inorganic thin film is formed as the second layer, it may be formed using an electron-beam evaporation method, a sputtering method, or a plasma CVD method as described above. In an embodiment of the invention, the antireflection film consisting only of the low-refractive-index layer composed of the two layers may be formed a release sheet. The low-refractive-index layer may be formed by any appropriate method.

The solvent, the method for preparing the low-refractive-index layer-forming coating liquid, and the method for forming the film are described below.

(Solvents)

Any type of solvent for dissolving or dispersing solid components is necessary for the layer-forming coating liquid. Examples of such a solvent include ketones such as acetone, methyl ethyl ketone, cyclohexanone, methyl isobutyl ketone, and diacetone alcohol; esters such as methyl formate, methyl acetate, ethyl acetate, butyl acetate, and ethyl lactate; nitrogen-containing compounds such as nitromethane, acetonitrile, N-methylpyrrolidone, and N,N-dimethylformamide; glycols such as methyl glycol and methyl glycol acetate; ethers such as tetrahydrofuran, 1,4-dioxane, dioxolane, and diisopropyl ether; halogenated hydrocarbons such as methylene chloride, chloroform, and tetrachloroethane; glycol ethers such as methyl cellosolve, ethyl cellosolve, butyl cellosolve, and cellosolve acetate; alcohols such as methanol, ethanol and isopropyl alcohol; aromatic hydrocarbons such as toluene and xylene; other solvents such as dimethylsulfoxide and propylene carbonate; and any mixture thereof.

The amount of the solvent may be appropriately controlled such that each component can be uniformly dissolved or dispersed in the solvent, the aggregation of the void-containing inorganic fine particles can be prevented even when the preparation is allowed to stand, and the concentration of the coating is not too low. As long as these requirements are satisfied, the amount of the addition of the solvent is preferably as small as possible such that a high concentration coating liquid can be prepared. As a result, the coating liquid can be stored in a small volume and diluted to an appropriate concentration when used for a coating process . Based on 100 parts by mass of the sum of the solids and the solvent, 50 to 99.5 parts by mass of the solvent is preferably used with 0.5 to 50 parts by mass of the total solids, and 70 to 97 parts by mass of the solvent is more preferably used with 3 to 30 parts by mass of the total solids, so that a low-refractive-index layer-forming coating liquid with high dispersion stability suitable for long-term storage can be obtained.

(Preparation of Coating Liquids)

The layer-forming coating liquid may be prepared by adding and mixing the respective essential components and an optional component in any order. When the void-containing inorganic fine particles are in the form of a colloid, they may be mixed without being processed. When they are in the form of a powder, a medium such as beads may be added to the resulting mixture and then subjected to an appropriate dispersion process with a paint shaker, a bead mill or the like, so that the layer-forming coating liquid can be obtained.

(Formation of Film)

The first layer-forming coating liquid or the second layer-forming coating liquid may be applied to an optically-transparent substrate, one or more functional layers, or the first layer, dried, and then optionally cured by ionizing irradiation and/or heating.

Any of various coating methods such as spin coating, dipping, spraying, die coating, bar coating, roll coating, meniscus coating, flexographic printing, screen printing, and bead coating may be used.

[Physical Properties of the Low-Refractive-Index Layer]

The minimum reflectance of the low-refractive-index layer of the antireflection film according to the invention can be preferably reduced to 2.5% or less, more preferably to 2% or less.

Concerning water resistance, the low-refractive-index layer of the antireflection film of the invention preferably shows a minimum reflectance difference of 0.1% or less before and after a process that includes dropping 1 mL of ion exchanged water on the low-refractive-index layer, allowing the layer to stand at 25° C. for 24 hours, and then wiping the water drop off the layer. In this context, a minimum reflectance difference of 0.1% or less (at most 0.1%) means that for example, when the minimum reflectance is 2.5% before the dropping, the minimum reflectance is in the range of 2.4% to 2.6% after the dropping.

Concerning water resistance, the low-refractive-index layer of the antireflection film of the invention preferably shows no appearance change (such as no water stain) before and after a process that includes dropping 1 mL of ion exchanged water on the low-refractive-index layer, allowing the layer to stand at 25° C. for 24 hours, and then wiping the water drop off the layer.

Concerning water resistance, the low-refractive-index layer of the antireflection film of the invention also preferably shows a haze difference of 0.1% or less, according to JIS K 7361, before and after a process that includes dropping 1 mL of ion exchanged water on the low-refractive-index layer, allowing the layer to stand at 25° C. for 24 hours, and then wiping the water drop off the layer. In this context, a haze difference of 0.1% or less (at most 0.1%) means that for example, when the haze is 0.3% before the dropping, the haze is in the range of 0.2% to 0.4% after the dropping.

Concerning scratch resistance, the low-refractive-index layer of the antireflection film of the invention also preferably has no scratch when the surface of the low-refractive-index layer is rubbed 10 times with #0000 steel wool under a minimum load of 200 g or more and then observed, after a process that includes dropping 1 mL of ion exchanged water on the low-refractive-index layer, allowing the layer to stand at 25° C. for 24 hours, and then wiping the water drop off the layer.

Next, a substrate and functional layers used in another embodiment of the invention where the antireflection film is not a single low-refractive-index layer but a multilayer structure are listed and described in order below.

<Optically-Transparent Substrate>

The material for the optically-transparent substrate may be, but not limited to, a general antireflection film material. Examples of such a material include thermoplastic resins such as polyester (such as polyethylene terephthalate and polyethylene naphthalate), cellulose triacetate, cellulose diacetate, cellulose acetate butyrate, polyester, polyethersulfone, polysulfone, polypropylene, polymethylpentene, polyvinyl chloride, polyvinyl acetal, polyether ketone, poly(methyl methacrylate), polycarbonate, and polyurethane. Preferred examples include resin substrates such as films made of various resins such as polyester (such as polyethylene terephthalate and polyethylene naphthalate) and cellulose triacetate.

Besides the above, the optically-transparent substrate may be a film of an amorphous olefin polymer having an alicyclic structure (Cyclo-Olefin-polymer (COP)). Such a substrate may be made of a norbornene polymer, a monocyclic olefin polymer, a cyclic conjugated diene polymer, a vinyl alicyclic hydrocarbon polymer resin, or the like. Examples of such a polymer include Zeonex and Zeonor series (norbornene resins) manufactured by Nippon Zeon Co., Ltd., Sumilite FS-1700 manufactured by Sumitomo Bakelite Company Limited, Arton series (modified norbornene resins) manufactured by JSR Corporation, Apel series (cyclic olefin copolymers) manufactured by Mitsui Chemicals, Inc., Topas series (cyclic olefin copolymers) manufactured by Ticona, and Optrez OZ-1000 series (alicyclic acrylic resins) manufactured by Hitachi Chemical Co., Ltd. FV series (low-birefringence, low-photoelasticity films) manufactured by Asahi Kasei Chemicals Corporation are also preferred as an alternative base material to triacetylcellulose. The thickness of the substrate is generally, but not limited to, from about 25 μm to about 1000 μm, or may be from about 1 mm to about 5 mm.

<Hard Coat Layer>

A hard coat layer may be provided in order to improve the performance of the antireflection film, such as scratch resistance and strength. The hard coat layer is intended to include a layer that exhibits a hardness of “H” or higher in the pencil hardness test according to JIS K 5600-5-4 (1999). The hard coat layer is preferably formed using an ionizing radiation-curable resin composition, more preferably using an ionizing radiation-curable, (meth)acrylate functional group-containing resin composition. Examples of materials that may be used for the resin composition include relatively low molecular weight polyester resins, polyether resins, acrylic resins, epoxy resins, urethane resins, alkyd resins, spiroacetal resins, polybutadiene resins, polythiol-polyether resins, polyhydric alcohols, monomers such as polyfunctional compounds such as di(meth)acrylates such as ethylene glycol di(meth)acrylate and pentaerythritol di(meth)acrylate monostearate, tri(meth)acrylates such as trimethylolpropane tri(meth)acrylate and pentaerythritol tri(meth)acrylate, and pentaerythritol tetra(meth)acrylate derivatives and dipentaerythritol penta(meth)acrylate, and oligomers such as epoxy acrylate, urethane acrylate and the like.

A photopolymerization initiator may be appropriately selected from those listed above and used for the ionizing radiation-curable resin composition.

After curing, the hard coat layer preferably has a thickness of 0.1 to 100 μm, more preferably of 0.8 to 20 μm. If the thickness is less than 0.1 μm, hard coating performance can be insufficient. If it is more than 100 μm, the hard coat layer can be easily cracked by external impact.

In an embodiment of the invention, the hard coat layer made from the ionizing radiation-curable resin composition may also function as the medium-refractive-index layer or the high-refractive-index layer as described below.

<Antistatic Layer>

The antireflection film may be provided with an antistatic layer for preventing generation of static electricity, avoiding deposition of dust, or suppressing external static electricity problems. The antistatic layer preferably serves to reduce the surface resistance of the antireflection film to 10¹² Ω/square or less. However, the surface resistance may be 10¹² Ω/square or more, as long as such functions as suppression of static electricity can be performed.

The antistatic material may be, but not limited to, an ion conducting material, an electron conducting material, inorganic fine particles, or the like.

Examples of antistatic agents for use in an antistatic layer-forming resin composition include various types of surfactant-based antistatic agents such as various types of cationic antistatic agents each having a cationic group such as a quaternary ammonium salt, a pyridinium salt, or any of primary to tertiary amino groups; anionic antistatic agents each having an anionic group such as a sulfonate group, a sulfuric ester group, a phosphoester group, or a phosphonate group; amphoteric antistatic agents such as an amino acid type and an amino-sulfate type; nonionic antistatic agents such as an amino alcohol type, a glycerin type and a polyethylene glycol type; organometallic compounds such as alkoxides of tin or titanium; metallic chelating compounds such as acetyl acetonate salts thereof; and polymer antistatic agents such as polymers of the above antistatic agents. Polymerizable antistatic agents may also be used such as monomers or oligomers that have a tertiary amino group, a quaternary ammonium group, or a metal chelate moiety and is polymerizable by ionizing irradiation; and organometallic compounds having a functional group polymerizable by ionizing irradiation, such as coupling agents. The antistatic agent may also be an electrically-conductive polymer. Examples of such a polymer include aliphatic conjugated polyacetylene, aromatic conjugated poly(paraphenylene), heterocyclic conjugated polypyrrole or polythiophene, and heteroatom-containing conjugated polyaniline, and mixed type conjugated poly(phenylenevinylene). Other examples include electrically-conductive complexes such as a multi-chain conjugated type having different conjugated chains in the molecule; and polymers in which the conjugated polymer chain described above is graft-polymerized or block-copolymerized with a saturated polymer.

Inorganic oxide fine particles with a particle size of 100 nm or less such as tin oxide, tin-doped indium oxide (ITO), antimony-doped tin oxide (ATO), indium-doped zinc oxide (AZO), antimony oxide, or indium oxide fine particles may be used as another antistatic agent for use in the antistatic layer-forming resin composition. Specifically, the particle size should be set at 100 nm or less, which is not longer than the visible light wavelength, so that the film containing the particle becomes transparent. Therefore, the transparency of the antireflection film is not degraded.

The antistatic layer may be directly placed on the optically-transparent substrate. Alternatively, the antistatic agent maybe dispersed in the hard coat layer to produce the same effect. As long as the desired refractive index is achievable, an antistatic agent comprising an organic component may be directly added in the low-refractive-index layer, or an antistatic layer with a thickness of 30 nm or less that does not affect the performance of the antireflection film may be provided on the uppermost surface of the low-refractive-index layer.

<High-Refractive-Index Layer and Medium-Refractive-Index Layer>

In a preferred embodiment of the invention, any other refractive index layer (a high-refractive-index layer and a medium-refractive-index layer) may be provided to further improve the antireflective properties.

The refractive indices of these refractive index layers may be freely selected in the range of 1.46 to 2.00. As used herein, the term “medium-refractive-index layer” is intended to include a layer having a refractive index at least higher than that of the low-refractive-index layer and having a refractive index in the range of 1.46 to 1.80, and the term “high-refractive-index layer” is intended to include a layer that has a refractive index in the range of 1.65 to 2.00 and has a refractive index at least higher than that of the medium-refractive-index layer when the medium-refractive-index layer is used together. These refractive-index layers may be made of a binder and ultrafine particles having a particle size of 100 nm or less and a specific refractive index. Examples of such fine particles include fine particles of zinc oxide (1.90), titania (2.3 to 2.7), seria (1.95), tin-doped indium oxide (1.95), antimony-doped tin oxide (1.80), yttria (1.87), and zirconia (2.0), wherein each number in the parentheses indicates the refractive index.

The ultrafine particles preferably have a refractive index higher than that of the binder. The refractive index of the refractive index layer generally depends on the content of the ultrafine particles, and, therefore, the higher the content of the ultrafine particles, the higher the refractive index of the refractive index layer. Therefore, the content ratio between the binder and the ultrafine particles may be controlled so that a high-refractive-index layer and a medium-refractive-index layer each with a refractive index in the range of 1.46 to 1.80 can be formed. If the ultrafine particles are electrically-conductive, another refractive index layer (high-refractive-index layer or medium-refractive-index layer) produced with the ultrafine particles can also have antistatic properties. The high-refractive-index layer or the medium-refractive-index layer may also be a vapor-deposited film of an inorganic oxide with a relatively high refractive index, such as titania or zirconia, formed by vapor deposition such as chemical vapor deposition (CVD) and physical vapor deposition (PVD). Alternatively, the high-refractive-index layer or the medium-refractive-index layer may be a film of a dispersion of fine particles of an inorganic oxide with a relatively high refractive index, such as titania.

The other refractive index layers preferably have a thickness of 10 to 300 nm, more preferably of 30 to 200 nm.

While the other refractive index layers (the high-refractive-index layer and the medium-refractive-index layer) may be formed directly on the optically-transparent substrate, they are preferably placed between the low-refractive-index layer and the hard coat layer formed on the optically-transparent substrate.

According to JIS K 7361, the haze of the antireflection film of the invention obtained as described above after the application of all layers is preferably equal to the haze of the optically-transparent substrate or preferably such that the difference between the hazes of the antireflection film and the optically-transparent substrate is within 1.5%.

The antireflection film of the invention also preferably has a water vapor permeability of 50 g/m² per day or less, more preferably of 10 g/m² per day or less, in the measurement using a water vapor-gas permeability meter (PERMATRAN-W3/31 manufactured by Modern Control Inc.) under the conditions of 40° C. and 90% RH according to JIS K 7129.

In view of water resistance, the antireflection film of the invention preferably shows a minimum reflectance difference of 0.1% or less and a haze difference of 0.1% or less according to JIS K 7361, before and after a process that includes dropping 1 mL of ion exchanged water on the surface of the antireflection film, allowing the film to stand at 25° C. for 24 hours, and then wiping the water drop off the surface.

The antireflection film of the invention also preferably has no scratch when the surface of the antireflection film is rubbed 10 times with #0000 steel wool under a minimum load of 200 g or more and then observed, after a process that includes dropping 1 mL of ion exchanged water on the surface of the antireflection film, allowing the film to stand at 25° C. for 24 hours, and then wiping the water drop off the film.

The embodiments described above are not intended to limit the scope of the invention. It will be understood that the embodiments are merely illustrative and that any subject including the same elements as those of the technical idea recited in each of Claims and providing the same effect or advantage will be encompassed in the technical scope of the invention.

### EXAMPLES

The invention is more specifically described below using some examples, which are not intended to limit the scope of the invention. In the examples, the term “part (or parts)” means part (or parts) by mass, unless otherwise stated.

### Example 1

(1) Formation of Hard Coat Layer

(Preparation of Hard Coat Layer-Forming Composition)

A hard coat layer-forming composition was prepared by mixing the following components: 30.0 parts by mass of pentaerythritol triacrylate (PET-30 (trade name), manufactured by Nippon Kayaku Co., Ltd.); 1.5 parts by mass of Irgacure 907 (trade name) manufactured by Ciba Specialty Chemicals Inc.; and 73.5 parts by mass of methyl isobutyl ketone.

(Preparation of Hard Coat Layer)

The prepared hard coat layer-forming composition was applied to an 80 μm thick triacetylcellulose (TAC) film by bar coating. After the solvent was removed by drying, the coating was cured by ultraviolet irradiation with a dose of about 20 mJ/cm² in an ultraviolet radiation system so that a laminated film composed of the substrate and a 10 μm thick hard coat layer was obtained.

(2) Formation of Low-Refractive-Index Layer

(Preparation of First Layer-Forming Composition)

A first layer-forming composition was prepared by mixing the following component: 16.64 parts by mass of a dispersion liquid of hollow silica fine particles (methyl isobutyl ketone hollow silica sol, 50 nm in average particle size, 20% in solids content, manufactured by Catalysts & Chemicals Ind. Co., Ltd.); 1.66 parts by mass of pentaerythritol triacrylate (PET-30 (trade name), manufactured by Nippon Kayaku Co., Ltd.); 0.06 parts by mass of Irgacure 369 (trade name) manufactured by Ciba Specialty Chemicals Inc.; and 81.44 parts by mass of methyl isobutyl ketone.

(Preparation of Second Layer-Forming Composition)

A second layer-forming composition was prepared by mixing the following components: 20 parts by mass of a fluorine atom-containing curable binder resin (Opstar JM5010 (trade name) manufactured by JSR Corporation, 1.41 in refractive index, 10% by mass in solids content, a methyl ethyl ketone solution); 0.1 parts by mass of Irgacure 369 (trade name) manufactured by Ciba Specialty Chemicals Inc.; and 21.9 parts by mass of methyl isobutyl ketone.

(Preparation of Low-Refractive-Index Layer)

The prepared first layer-forming composition was applied to the laminated film of substrate/hard coat layer obtained in the section (1) by bar coating. After the solvent was removed by drying, the coating was cured by ultraviolet irradiation with a dose of 80 mJ/cm² in an ultraviolet radiation system (H bulb light source, Fusion UV Systems Japan KK) so that an about 60 nm thick first layer was formed. The prepared second layer-forming composition was then applied thereto by bar coating. After the solvent was removed by drying, the coating was cured by ultraviolet irradiation with a dose of 200 mJ/cm² in an ultraviolet radiation system (H bulb light source, Fusion UV Systems Japan KK) so that an about 30 nm thick second layer was formed. As a result, a low-refractive-index layer with a total thickness of about 90 nm was obtained.

The resulting antireflection film was evaluated for refractive index, minimum reflectance, haze, scratch resistance, and water vapor permeability, as described below. After 1 mL of ion exchanged water was dropped on the surface of the resulting antireflection film, the film was allowed to stand at room temperature for 24 hours. After this water resistance test, the film was evaluated for appearance change, refractive index, minimum reflectance, haze, and scratch resistance. The results are shown in Table 1 below.

[Evaluation Methods]

(1) Refractive Index and Minimum Reflectance

The absolute reflectance was measured with a spectrophotometer (UV-3100PC manufactured by Shimadzu Corporation). Each absolute reflectance is shown in Table 1. The thickness of the low-refractive-index layer was selected such that the reflectance became minimal at a wavelength of about 550 nm.

The refractive index of the low-refractive-index layer was determined by simulation using the resulting reflectance curve.

(2) Haze (Transparency)

The haze was measured with a turbidimeter (NDH2000 manufactured by Nippon Denshoku Industries Co., Ltd.) according to JIS K 7361.

(3) Scratch Resistance Evaluation Test

Steel wool #0000 was reciprocated 20 times under a load of 200 g, and then the presence or absence of scratches was visually examined. The evaluation was performed according to the following criteria:
o: Scratches were not observed at all.
o-Δ: Fine scratches (5 or less) were observed.
Δ: The film was significantly scratched, but separation was not observed.
x: The film was separated.

(4) Water Vapor Permeability Measurement

The water vapor permeability was measured with a water vapor-gas permeability meter (PERMATRAN-W3/31 manufactured by Modern Control Inc.) under the conditions of 40° C. and 90% RH according to JIS K 7129.

### Example 2

An antireflection film was prepared using the process of Example 1, except that the thicknesses of the first and second layers were changed to 50 nm and 45 nm, respectively, so that a low-refractive-index layer with a total thickness of 95 nm was formed and that the second layer-forming composition described below was used.

The resulting antireflection film was evaluated for appearance change, refractive index, minimum reflectance, coating film transparency, and scratch resistance before and after the water resistance test in the same manner as in Example 1. The results are shown in Table 1 below.

(Preparation of Second Layer-Forming Composition)

A second layer-forming composition was prepared by mixing the following components: 1 part by mass of 1H,1H,6H,6H-perfluoro-1,6-hexyl diacrylate (CH₂═CHCOOCH₂(CF₂)₄CH₂COOCCH═CH₂) (manufactured by AZmax Co.); 0.5 parts by mass of pentaerythritol triacrylate (PET-30 (trade name), manufactured by Nippon Kayaku Co., Ltd.); 0.1 parts by mass of Irgacure 369 (trade name) manufactured by Ciba Specialty Chemicals Inc.; and 28.5 parts by mass of methyl isobutyl ketone.

### Example 3

An antireflection film was prepared using the process of Example 1, except that a silicon oxide film was formed as the second layer of the low-refractive-index layer.

A laminate of TAC substrate/hard coat layer/first layer (hollow silica composition layer) was formed under the same conditions as in Example 1. The laminate was mounted on the lower electrode in the chamber of a sputtering system such that the hollow silica composition surface (film forming surface) of the first layer faced upward. The pressure in the chamber was then reduced to an ultimate vacuum of 0.0005 Pa using an oil rotary pump and a turbo-molecular pump. The sputtering system including the chamber, a power source, an exhaust valve, an exhaust unit, and a gal inlet was used. Silicon as the target and oxygen gas (99.9999% or more in purity, manufactured by Taiyo Toyo Sanso Co., Ltd.) were prepared.

An electric power (input electric power 2 kW) was then applied to the lower electrode. Oxygen was introduced at 2 sccm from the gas inlet placed near the electrode into the chamber. The opening degree of the exhaust valve placed between the exhaust unit and the chamber was controlled so that the pressure in the film forming chamber was kept at 0.2 Pa, and a 30 nm thick inorganic thin film of silicon oxide was formed on the base film. The term “sccm” is an abbreviation for standard cubic centimeter per minute.

The resulting antireflection film was evaluated for appearance change, refractive index, minimum reflectance, coating film transparency, and scratch resistance before and after the water resistance test in the same manner as in Example 1. The results are shown in Table 1 below.

### Example 4

An antireflection film was prepared using the process of Example 3, except that the thickness of the first layer of the hollow silica composition and the thickness of the second layer of the silicon oxide film were changed to 80 nm and 10 nm, respectively, so that a low-refractive-index layer with a total thickness of 90 nm was formed.

The resulting antireflection film was evaluated for appearance change, refractive index, minimum reflectance, coating film transparency, and scratch resistance before and after the water resistance test in the same manner as in Example 1. The results are shown in Table 1 below.

### Example 5

An antireflection film was prepared using the process of Example 3, except that an aluminum oxide film was formed as the second layer and that the thickness of the first layer of the hollow silica composition and the thickness of the second layer were changed to 70 nm and 20 nm, respectively, so that a low-refractive-index layer with a total thickness of 90 nm was formed.

In the same sputtering system as in Example 3, aluminum as the target and oxygen gas (99.9999% or more in purity, manufactured by Taiyo Toyo Sanso Co., Ltd.) were used, and a 20 nm thick inorganic thin film of aluminum oxide was formed on the base film under the same conditions.

The resulting antireflection film was evaluated for appearance change, refractive index, minimum reflectance, coating film transparency, and scratch resistance before and after the water resistance test in the same manner as in Example 1. The results are shown in Table 1 below.

### Comparative Example 1

A fluoride additive generally used as an antifouling agent was added to a low-refractive-index layer containing hollow silica fine particles, when an antireflection film was prepared.

(1) Formation of Hard Coat Layer

A laminated film composed of a substrate and a hard coat layer was obtained in the same manner as in Example 1.

(2) Formation of Low-Refractive-Index Layer

(Preparation of Low-Refractive-Index Layer-Forming Composition)

A low-refractive-index layer-forming composition was prepared by mixing the following components: 14.94 parts by mass of the dispersion liquid of hollow silica fine particles as used in Example 1; 1.99 parts by mass of pentaerythritol triacrylate (PET-30 (trade name), manufactured by Nippon Kayaku Co., Ltd.); 0.07 parts by mass of Irgacure 369 (trade name) manufactured by Ciba Specialty Chemicals Inc.; 0.66 parts by mass of an antifouling agent (a fluoride additive, Modiper FS 720 (trade name) manufactured by NOF Corporation; and 82.33 parts by mass of methyl isobutyl ketone.

TABLE 1

| | | Example | Example | Example | Example | Example | Comparative |
|---|---|---|---|---|---|---|---|
| | | 1 | 2 | 3 | 4 | 5 | Example 1 |
| Before | Refractive | 1.37 | 1.38 | 1.38 | 1.36 | 1.39 | 1.37 |
| Water | Index | | | | | | |
| Resist- | Minimum | 1.3 | 1.5 | 1.5 | 1.1 | 1.7 | 1.3 |
| ance | Reflectance | | | | | | |
| Test | (%) | | | | | | |
| | Haze (%) | 0.3 | 0.3 | 0.3 | 0.3 | 0.3 | 0.3 |
| | Scratch | ∘ | ∘ | ∘ | ∘ | ∘ | ∘ |
| | Resistance | | | | | | |
| After | Appearance | Not | Not | Not | Not | Not | Observed |
| Water | Change | Observed | Observed | Observed | Observed | Observed | (Water stain) |
| Resist- | Refractive | 1.37 | 1.38 | 1.38 | 1.36 | 1.39 | 1.41 |
| ance | Index | | | | | | |
| Test | Minimum | 1.3 | 1.5 | 1.5 | 1.1 | 1.7 | 1.9 |
| | Reflectance | | | | | | |
| | (%) | | | | | | |
| | Haze (%) | 0.3 | 0.3 | 0.3 | 0.3 | 0.3 | 0.5 |
| | Scratch | ∘ | ∘ | ∘ | ∘ | ∘ | Δ |
| | Resistance | | | | | | |

| | | | | | | |
|---|---|---|---|---|---|---|
| Water Vapor | 28 | 22 | 9 | 19 | 13 | 633 |
| Permeability | | | | | | |
| (g/m² day) | | | | | | |

The antireflection films obtained in Examples 1 to 5 according to the invention each had a low-refractive-index layer composed of two layers and had a water vapor permeability of 50 g/m² per day or less. The antireflection films according to the invention all had low reflectivity and showed a minimum-reflectance difference of 0% and a haze difference of 0% before and after the water resistance test and thus were highly resistant to water and resistant to degradation in reflectance, appearance, or scratch resistance over time.

In contrast, the water vapor permeability was high in Comparative Example 1 in which a fluoride additive conventionally used as an antifouling agent was added to the low-refractive-index layer containing void-containing inorganic fine particles. In Comparative Example 1, degraded appearance such as water stain was observed after the water resistance test, and the minimum reflectance difference and the haze difference were 0.6% and 0.2%, respectively. Such degradation in optical properties and mechanical or physical properties indicates insufficient water resistance.

What we claim is:

1. An antireflection film, comprising: a low-refractive-index layer composed of two layers, the two layers comprising a first layer which comprises a cured film that is formed by curing an ethylenically unsaturated bond-containing monomer or oligomer and contains void-containing inorganic fine particles, and a second layer that is formed on the first layer and comprises a cured film formed by curing a composition comprising a monomer that has an fluorine atom and, in a molecule thereof, two or more ethylenically unsaturated bonds.

2. The antireflection film according to claim 1, wherein the void-containing inorganic fine particles are hollow silica fine particles.

3. The antireflection film according to claim 1, wherein the void-containing inorganic fine particles are surface-treated with a silane coupling agent having an acryloyl group and/or a methacryloyl group.

4. The antireflection film according to claim 1, wherein the antireflection film has a water vapor permeability of 50 g/m² or less in a measurement under the conditions of 40° C. and 90% RH according to JIS K 7129.

5. The antireflection film according to claim 1, wherein the antireflection film shows a minimum reflectance difference of 0.1% or less and a haze difference of 0.1% or less according to JIS K 7361, before and after a process that comprises dropping 1 mL of ion exchanged water on the surface of the antireflection film, allowing the film to stand at 25° C. for 24 hours, and then wiping the water drop off the surface.
